(19) United States
(12) Patent Application Publication
(10) Pub. No.: US 2018/0097626 A1
(43) Pub. Date: Apr. 5, 2018

(54) SECURE ACCOUNT ACCESS CONTROL

(71) Applicant: Intel Corporation, Santa Clara, CA (US)

(72) Inventors: David I. Poisner, Carmichael, CA (US); Yuri Krimon, Folsom, CA (US)

(21) Appl. No.: 15/282,253

(22) Filed: Sep. 30, 2016

(51) Int. Cl. H04L 9/32; H04L 29/06

(52) U.S. Cl. CPC H04L 9/32; H04L 63/083; H04L 63/0428

(57) ABSTRACT

Various systems and methods for providing secure account access controls for executors are described herein. A system for secure account access control includes a communication circuit to receive, from a client computer associated with a human client: an encrypted payload, the encrypted payload encrypted with a representative key associated with a human representative, the human representative having an in-person relationship with the human client; and configuration data including a list of recipients, the list including the human representative; and a cryptographic circuit to encrypt the encrypted payload with a platform key, to produce a doubly-encrypted payload; where the communication circuit is to transmit the doubly-encrypted payload to those on the list of recipients.

### TECHNICAL FIELD

Embodiments described herein generally relate to computer security and in particular, to secure account access controls.

### BACKGROUND

Paperless transactions, online accounts, and other secure mechanisms create difficult situations for spouses, executors, or conservators who have to access resources after an account holder passes away or becomes incapacitated. It takes significant time and resources to contact organizations, provide proper proof of ownership, and perform other activities to access accounts, transfer assets, and take control of the former account holder. Additionally, determining who should have access to a deceased or incapacitated person's accounts is a difficult task. What is needed is a system to address these and other issues that arise after a person dies or becomes incapacitated.

### BRIEF DESCRIPTION OF THE DRAWINGS

In the drawings, which are not necessarily drawn to scale, like numerals may describe similar components in different views. Like numerals having different later suffixes may represent different instances of similar components. Some embodiments are illustrated by way of example, and not limitation, in the figures of the accompanying drawings in which:

FIG. 1 is a schematic drawing illustrating control and data flow, according to an embodiment;

FIG. 2 is a schematic drawing illustrating control and data flow, according to an embodiment;

FIG. 3 is a block diagram illustrating service platform for secure account access control, according to an embodiment;

FIG. 4 is a flowchart illustrating a method for secure account access control, according to an embodiment; and

FIG. 5 is a block diagram illustrating an example machine upon Which any one or more of the techniques (e.g., methodologies) discussed herein may perform, according to an example embodiment.

### DETAILED DESCRIPTION

In the following description, for purposes of explanation, numerous specific details are set forth in order to provide a thorough understanding of some example embodiments. It will be evident, however, to one skilled in the art that the present disclosure may be practiced without these specific details.

Disclosed herein are systems and methods that provide secure account access controls. Executors are people who are appointed by a testator to carry out the terms of the testator's will. Conservators (also referred to as adult guardians in some situations) are people who are appointed to handle an incapacitated person's affairs. The incapacitated person is referred to as a conservatee. A person may be deemed legally incapacitated for a number of reasons, such as by having a physical or mental deficiency, disability, or other impairment. Examples of incapacity include, but are not limited to those who are in a coma, suffering from Alzheimer's, or those who have a severe drug addiction. Executors or conservators take significant time and effort to provide documentation, such as death certificates, wills, court orders, or other supporting documents, in order to gain access to online accounts of the people they are helping. For example, it is not unusual for an executor or conservator to spend hours on the phone to contact people at various organizations, obtain and prepare documents, obtain notarizations, and organizing responses for each account of the testator or conservatee.

One mechanism to streamline the process is for the testator or conservatee to prepare and provide a list of usernames and passwords for the various accounts. This list may be used by the respective executor or conservator after the death or incapacitation. However, this mechanism may be insecure in that the executor or conservator may access the accounts before the proper time. Fraud or other malfeasance may be performed while the account holder is still actively using the account. Additionally, the list may be stolen from the executor or conservator, which may produce its own set of issues. What is needed is a secure, streamlined mechanism to provide account information to the appropriate people at an appropriate time.

The mechanisms described herein provide the following benefits. First, there are minimal delays for an executor or conservator to gain access to the accounts after death or incapacitation of the account holder. For example, access may be granted in hours or days, instead of weeks. Second, there is minimal effort and expense for the executor or conservator. For example, there is no need to spend hours per account contacting human operators at the businesses and convincing them to release the username or password details. Third, the mechanism prevents premature access to the accounts by executors or conservators. Fourth, there is minimal overhead or costs to the user. The service may be provided at a reasonable rate due to the simplicity of the mechanisms involved.

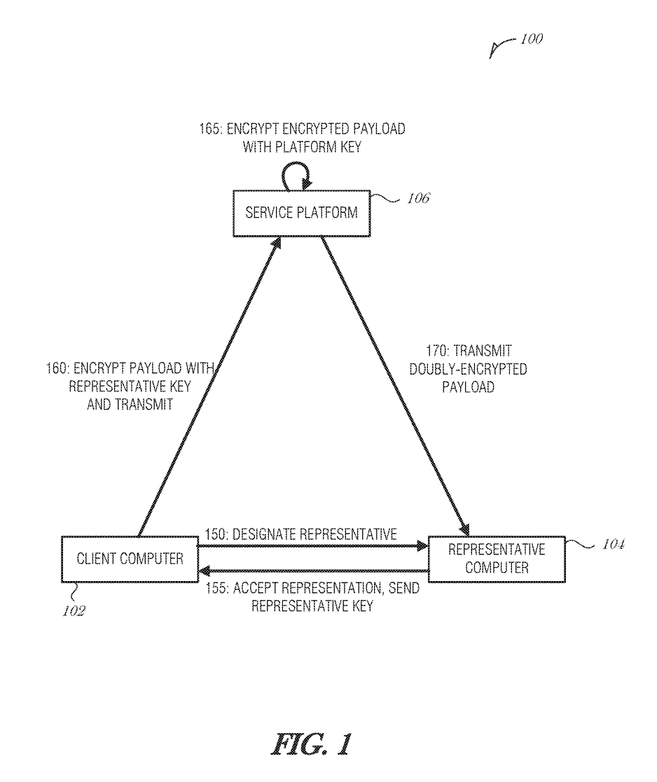

FIG. 1 is a schematic drawing illustrating control and data flow 100, according to an embodiment. In the control and data flow 100 illustrated in FIG. 1, a person signs up or enrolls in a service. The service provides a safe and secure repository for the person's online account information. The online account information may include account numbers, usernames, passwords, personal identification numbers (PINs), answers to secret questions, and other sensitive information that is used to access and control online accounts.

The person (referred to as a “client”) operates a client computer 102 and designates a representative computer 104 (operation 150). The representative, who is a human and controls the representative computer, may be an executor, conservator, or other legal custodian or representative of the client. The designation operation 150 may be performed using a computer-to-computer communication, such as with a signed message from the client computer 102 to the representative computer 104. The signed message may be signed with a private key associated with the client computer 102 or the client. The message may be a request for the representative to accept or deny the role of a representative to the client. Alternatively, the designation operation 150 may be performed out of band, such as with paperwork, an oral agreement, or other mechanisms.

At operation 155, the representative accepts the representation and sends a representative key to the client computer 102. The representative key may be a public key associated with a private key held by the representative. For instance, the representative key may be a private key using in a public key infrastructure (PKI) scheme (also referred to as an asymmetric algorithm), such as RSA or Pretty Good Privacy (PGP). Alternatively, the representative key may be a symmetric key, and may involve algorithms such as Twofish, Blowfish, Triple Data Encryption Algorithm (DES), or Advanced Encryption Standard (AES).

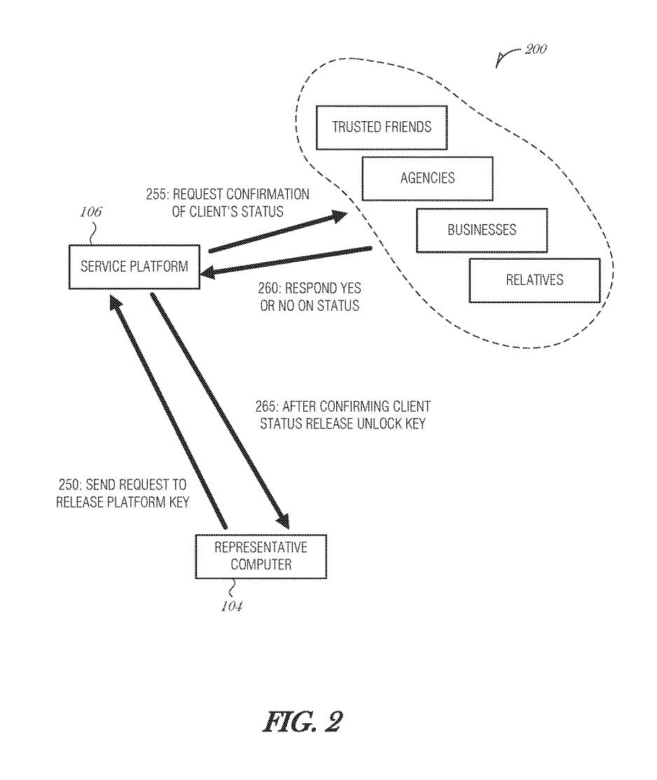

At operation 160, the client computer encrypts a payload with the representative key and transmits the encrypted payload to a service platform 106. The payload may include various sensitive information that the client wants to keep in a safe and secure spot. The sensitive information is for use by the representative after the client becomes incapacitated or deceased. In addition to the payload, the client computer 102 may transmit additional information related to the encrypted payload including a list of one or more people who may act as a representative, a list of one or more people to distribute the doubly-encrypted payload (discussed more in operation 170 below), a list of one or more people to contact to verify the client's death or incapacity (discussed more in FIG. 2 below), payment information, or other information.

Although only one payload data is illustrated in FIG. 1, it is understood that multiple payloads may be encrypted and transmitted in the manner described herein. For instance, the client may create one payload for one executor and a second payload, which may be a duplicate, for a second backup executor. As another example, the client may create iterations of payloads over time, such that a first payload may be created at a first time and a second payload may be created later and include more or different information than the first payload. Such examples may be combined such that different representatives may obtain one or more payloads from the client. The executor, conservator, or legal representative may later request multiple keys from the service platform 106 to decrypt all available payloads provided to the service platform 106 by the client and for the representative (see discussion of operation 265 in FIG. 2 below).

The service platform 106 may operate as a cloud service, software as a service, a centralized service, or other type of computing platform. The service platform 106 operates as a storage repository for the client's encrypted payload. By using a network storage location, the encrypted payload information is more guaranteed to survive for years or decades without data loss.

At operation 165, the service platform 106 encrypts the encrypted payload with a platform key known only by the service platform 106, to produce a doubly-encrypted payload. The platform key may be a private key using in a PKI scheme, such as RSA or PGP. In order avoid data exposure, the private key may be used a limited number of times, even as few as a single use. Alternatively, the platform key may be a symmetric key, and may involve algorithms such as Twofish, Blowfish, Triple DES, or AES. The platform key is preferably unique to the client so that client data is not subject to hacking or other data loss.

At operation 170, the service platform 106 transmits the doubly-encrypted payload to the representative computer 104. At this stage, the service platform 106 does not have the sensitive data in the payload. The service platform 106 may discard it as a matter of policy. Alternatively, even if the service platform 106 maintains a copy of the payload, the payload is encrypted with at least the representative key (from operation 160). As such, the service platform 106 is unable to access the sensitive data in the payload because it is encrypted with the representative key.

Additionally, at this stage, the representative has a copy of the doubly-encrypted payload, but it cannot decrypt the payload because it does not have the platform key (encrypted in operation 165). However, with the doubly-encrypted payload in its possession, the representative is able to assure the client that the client's secure information may be used appropriately when the time comes.

In an alternative embodiment, the service platform 106 may maintain a copy of the doubly-encrypted payload at a storage device at the service platform 106. This may be used for storage redundancy.

FIG. 2 is a schematic drawing illustrating control and data flow 200, according to an embodiment. In the control and data flow 200 illustrated in FIG. 2, the client who enrolled in the service provided by the service platform 106 dies or becomes incapacitated. The control and data flow 200 illustrates the processes used to unroll the doubly-encrypted payload created in the flow 100 of FIG. 1.

The representative receives notice that the client is dead or incapacitated. Such notice may be provided by a relative of the client, a court, or other legal representative. The representative may then request a platform unlock key from the service platform 106 (operation 250). The platform unlock key is a key used to decrypt the doubly-encrypted payload. The platform unlock key may be the same as the platform key used to encrypt the doubly-encrypted payload (e.g., in a symmetric key mechanism) or may be a public key of the service platform 106 (e.g., in an asymmetric key mechanism).

Before releasing the unlock key to the representative computer 104, the service platform may initiate one or more processes (operations 255 and 260) to confirm the status of the client (e.g., that the client has passed away). The confirmation processes may be configured or set by the client during an initialization phase. For instance, the client may create a set of criteria such that at least five people on the list provided by the client respond to an inquiry and confirm the client's status. The client may provide email addresses, mailing addresses, phone numbers, or other contact information for a list of people to be used to verify or confirm the client's alleged status. The client may provide a large number of contact, such as twenty or more, and provide a threshold number that have to respond with a consistent response before the client's status is considered confirmed. This mechanism allows for the possibility that not all of the client's contacts may know of the client's condition when contacted to confirm. For example, a contact may be on vacation and not hear of an accident where the client was injured or killed, before being contacted by the service platform 106 to verify the client's condition. As such, the contact may provide erroneous information.

In addition to having a number of correlated positive responses (e.g., “yes, the client has passed away”), the confirmation process may also require that there be fewer than a threshold number of negative (or contrary) responses (e.g., “I don't know if the client has passed away,” or “no, the client has not passed away,” etc.). The allowable number of negative or contrary responses may be set to zero, such that if there are any responses to the contrary, then the service platform 106 may not release the platform unlock key.

Other confirmation processes may be used, such as checking public records for a death certificate, a newspaper announcement, an obituary, or a funeral announcement. Yet other confirmation processes may wait for data to arrive at the service platform 106. For instance, the confirmation process may not actively seek data, but may instead wait to receive an electronic death certificate sent by an official agency (e.g., a country records office). The confirmation process may check with various public and private agencies or businesses, such as a hospital, morgue, funeral home, adult care center, or the like.

In some embodiments, the service platform 106 communicates with friends, family, other contacts, businesses, government agencies, and other entities directly to confirm the status of the client. In other embodiments, the status may be proved with information provided by the representative. For example, the representative may query the contacts for their responses, and the responses may be sent directly to the service platform 106 to avoid the possibility of alteration. As another example, the representative may contact the funeral home or other entity and request that information be sent to the service platform 106 in order to prove the status of the client. It is understood that the service platform 106 may communicate directly with some entities and may communicate indirectly (e.g., with assistance from the representative) with other entities in order to confirm or verify the client's status.

After confirming the status of the client, the service platform 106 releases the unlock platform key to the representative computer 104 (operation 265). The representative computer then has both keys (the unlock platform key and the representative's own unlock key) and is able to fully decrypt the payload.

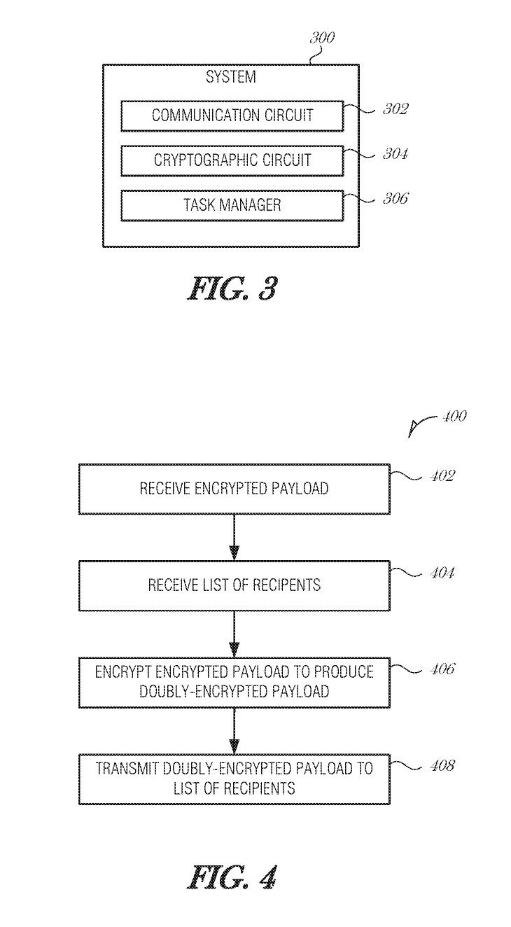

FIG. 3 is a block diagram illustrating service platform 300 for secure account access control, according to an embodiment. The service platform 300 includes a communication circuit 302, a cryptographic circuit 304, and a task manager 306. The communication circuit 302 may be configured to receive, from a client computer associated with a human client, an encrypted payload, where the encrypted payload is encrypted with a representative key associated with a human representative. The human representative is a person who has an in-person relationship with the human client.

The communication circuit 302 may also receive configuration data from the human client. The configuration data may include a list of recipients, with the list including the human representative. The list of recipients is used by the service platform 300 for eventual delivery of a doubly-encrypted payload, where the service platform 300 encrypts the encrypted payload.

As such, the cryptographic circuit 304 may be configured to encrypt the encrypted payload with a platform key, to produce a doubly-encrypted payload. Then, as discussed, the communication circuit 302 is to transmit the doubly-encrypted payload to those on the list of recipients.

The first-level encryption of the payload may be performed in any number of ways. In an embodiment, the encrypted payload is encrypted using an asymmetric key scheme, and wherein the representative key is a public key associated with the human representative. For instance, the payload may be encrypted using a public key provided by the human representative. In another embodiment, the encrypted payload is encrypted using a symmetric key scheme.

In an embodiment, the encrypted payload includes sensitive data associated with the human client. In a further embodiment, the sensitive data includes at least one of a username, a password, a personal identification number, or an account number. Other types of sensitive information may be provided in the payload by the human client, for instance, answers to secret questions, a personal image, a security image, a confidence image, a SiteKey, or other online authentication or authorization assets.

In an embodiment, the list of recipients includes at least one of an executor or a conservator of the human client.

In a further embodiment, the system 300 includes the task manager 306 coupled to the communication circuit 302, where the communication circuit 302 is configured to receive a request from the human representative to release an unlock platform key to decrypt the doubly-encrypted payload. The request may be a message created from a web form. The request may be an electronic message, such as an email message. The request may originate from a phone call, for example, via an interactive voice response (IVR) system. In response to the communication circuit 302 receiving the request to release the unlock platform key, the task manager 306 is configured to confirm a status of the human client before releasing the unlock platform key to the human representative.

In an embodiment, to confirm the status of the human client, the task manager 306 is configured to access a list of contacts provided by the human client. The list of contacts may include relatives, legal representatives, friends, or other people. The list of contacts may also include entities, such as a bank, a hospital, or a police department.

The task manager 306 is configured to query at least a portion of the contacts in the list of contacts to confirm the status of the human client and confirm the status of the human client based on the responses to the query from the contacts.

In an embodiment, to query the contacts in the list of contacts, the task manager 306 is configured to transmit an electronic message to the contacts in the list of contacts, the electronic message including a query of whether the contacts are able to confirm the status of the human client. The electronic message may be transmitted using various modes or mechanisms. For instance, the electronic message may be an email message, a text message, an automated phone call using an IVR system, or the like. Thus, in an embodiment, the electronic message is an email. In another embodiment, the electronic message incudes a link to a web survey. The web survey may request identifying information (e.g., the survey responder's name) and other information used to confirm or deny the person's status (e.g., whether the person is dead). In an embodiment, the electronic message is a text message.

In another embodiment, to query the contacts in the list of contacts, the task manager is configured to initiate delivery of a non-electronic message to the contacts in the list of contacts, the non-electronic message including a query of whether the contacts are able to confirm the status of the human client. The non-electronic message may be a paper delivered through courier or mail service.

In an embodiment, to query the contacts in the list of contacts, the task manager 306 is configured to transmit a request via an application programming interface (API) to the contacts in the list of contact. For instance, government or private entities may expose an API to check on a person's status. A morgue, for example, may expose an API over an Hypertext transfer protocol (HTTP), such that a computer system may transmit one or more packets with a query string to request the status of a person, who may be identified using a unique identifier (e.g., a driver's license number, a passport number, a social security number, etc.). Thus, in an embodiment, the request is transmitted to a government office via the application programming interface.

In an embodiment, to confirm the status of the human client based on the responses to the query from the contacts, the task manager 306 is to calculate a number of negative responses, the negative indicating that an expected status of the human client is not valid. For instance, the human representative may report that the human client has died. To confirm the status of the human client, e.g., that he is dead, the task manager 306 may query the contacts provided by the human client. A positive or negative response depends on how the query is formed, but in most cases the query may be formed as “Can you confirm that [human representative's assertion of human client's status] is true?” In other words, for example, the query may be “Can you confirm that Dave is dead?”

The task manager 306 may be configured to confirm the status of the human client when the number of negative responses is less than a threshold. For example, if fewer than five people of a list of twenty people respond that they are unsure or don't think that the person is dead, then the task manager 306 may see that the weight of the evidence is that the person is likely dead (e.g., fifteen people responding to confirm that the person is dead). In this case, the threshold of negative responses is not violated and the person's status is considered confirmed. The threshold may be any number, including zero, such that if anyone responds with a negative response, then the status is not confirmed. Thus, in an embodiment, the threshold is one negative response. In another embodiment, the threshold is a user configurable value, configured by the human client. For instance, the client may set the threshold when configuring the account. In another embodiment, the threshold is based on a ratio of positive responses to negative responses. For instance, if less than 10% of the responses are negative, then the status is considered confirmed.

In an embodiment, the status of the human client is an incapacitated status. In another embodiment, the status of the human client is a deceased status.

FIG. 4 is a flowchart illustrating a method 400 for secure account access control, according to an embodiment. At 402, an encrypted payload is received from a client computer associated with a human client, where the encrypted payload encrypted with a representative key associated with a human representative, the human representative having an in-person relationship with the human client. In an embodiment, the encrypted payload is encrypted using an asymmetric key scheme. In such an embodiment, the representative key is a public key associated with the human representative. In another embodiment, the encrypted payload is encrypted using a symmetric key scheme.

In an embodiment, the encrypted payload includes sensitive data associated with the human client. In a further embodiment, the sensitive data includes at least one of: a username, a password, a personal identification number, or an account number.

In an embodiment, the list of recipients includes at least one of: an executor or a conservator of the human client. Other recipients may be included on the list including, but not limited to, relatives, agencies, attorneys, or the like. The recipients will receive a doubly encrypted payload for safe keeping while the human client is still living with full faculties.

At 404, configuration data including a list of recipients is received from the client computer, the list including the human representative.

At 406, the encrypted payload is encrypted with a platform key, to produce a doubly-encrypted payload.

At 408, the doubly-encrypted payload is transmitted to those on the list of recipients.

At a later time, the human representative may submit a request to access the doubly-encrypted payload (e.g., the sensitive information of the human client). Thus, in an embodiment, the method 400 includes receiving a request from the human representative to release an unlock platform key to decrypt the doubly-encrypted payload and confirming a status of the human client before releasing the unlock platform key to the human representative. In an embodiment, the status of the human client is an incapacitated, status. In another embodiment, the status of the human client is a deceased status.

In an embodiment, confirming the status of the human client includes accessing a list of contacts provided by the human client. For instance, the human client may decide who to contact in case of an emergency or to confirm the status of the client in a dire situation. This contact list may be provided to the service platform for future use. The contact list may be updated to add or remove contacts. The method 400 includes querying at least a portion of the contacts in the list of contacts to confirm the status of the human client and confirming the status of the human client based on the responses to the query from the contacts.

In an embodiment, querying the contacts in the list of contacts includes transmitting an electronic message to the contacts in the list of contacts, the electronic message including a query of whether the contacts are able to confirm the status of the human client. The contact list may include various contact details of the contacts, such as the contact's name, phone number, email address, instant messaging handle, or the like. Thus, in an embodiment, the electronic message is an email. In another embodiment, the electronic message incudes a link to a web survey. In another embodiment, the electronic message is a text message.

Although one mechanism to reach contacts includes electronic mechanisms, such as email, other forms may be used as well, such as post mail. Thus, in an embodiment, querying the contacts in the list of contacts comprises initiating delivery of a non-electronic message to the contacts in the list of contacts, the non-electronic message including a query of whether the contacts are able to confirm the status of the human client. Accordingly, in an embodiment, the non-electronic message comprises a paper delivered through courier or mail service.

In an embodiment, querying the contacts in the list of contacts includes transmitting a request via an application programming interface to the contacts in the list of contact. In an embodiment, the request is transmitted to a government office via the application programming interface.

In an embodiment, confirming the status of the human client based on the responses to the query from the contacts includes calculating a number of negative responses, the negative indicating that an expected status of the human client is not valid and confirming the status of the human client when the number of negative responses is less than a threshold. In a further embodiment, the threshold is one (e.g., a single) negative response. In another embodiment, the threshold is a user configurable value, configured by the human client. In an embodiment, the threshold is based on a ratio of positive responses to negative responses.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

A processor subsystem may be used to execute the instruction on the machine-readable medium. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field programmable gate array (FPGA), or a fixed function processor.

Examples, as described herein, may include, or may operate on, logic or a number of components, modules, or mechanisms. Modules may be hardware, software, or firmware communicatively coupled to one or more processors in order to carry out the operations described herein. Modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

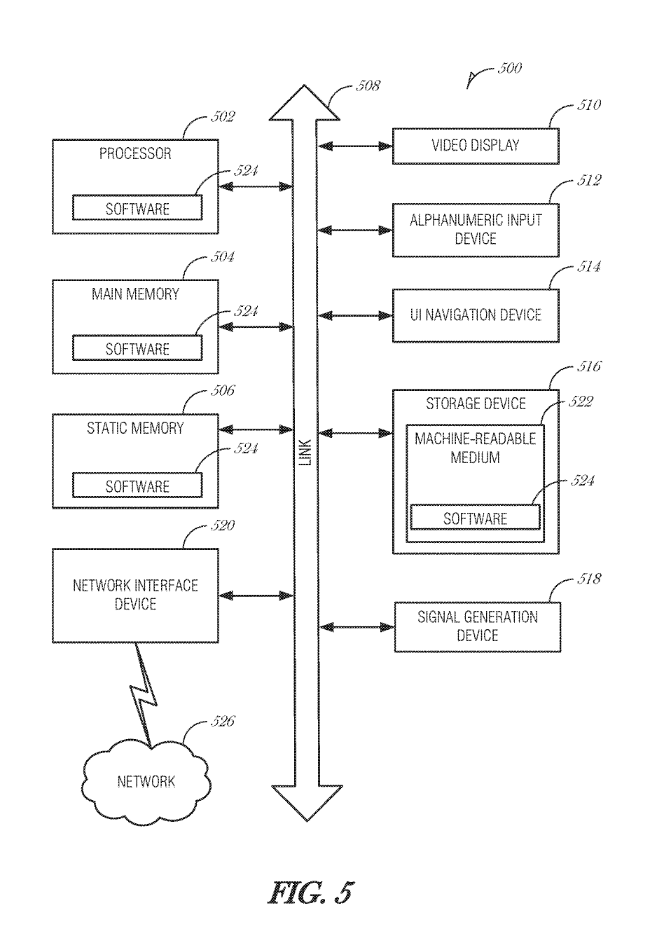

FIG. 5 is a block diagram illustrating a machine in the example form of a computer system 500, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 500 includes at least one processor 502 (e.g., a central processing unit (CPU), a graphics processing unit (GPU) or both, processor cores, compute nodes, etc.), a main memory 504 and a static memory 506, which communicate with each other via a link 508 (e.g., bus). The computer system 500 may further include a video display unit 510, an alphanumeric input device 512 (e.g., a keyboard), and a user interface (UI) navigation device 514 (e.g., a mouse). In one embodiment, the video display unit 510, input device 512 and UI navigation device 514 are incorporated into a touch screen display. The computer system 500 may additionally include a storage device 516 (e.g., a drive unit), a signal generation device 518 (e.g., a speaker), a network interface device 520, and one or more sensors (not shown), such as a global positioning system (GPS) sensor, compass, accelerometer, or other sensor.

The storage device 516 includes a machine-readable medium 522 on which is stored one or more sets of data structures and instructions 524 (e.g., software) embodying or utilized by any one or more of the methodologies or functions described herein. The instructions 524 may also reside, completely or at least partially, within the main memory 504, static memory 506, and/or within the processor 502 during execution thereof by the computer system 500, with the main memory 504, static memory 506, and the processor 502 also constituting machine-readable media.

While the machine-readable medium 522 is illustrated in an example embodiment to be a single medium, the term “machine-readable medium” may include a single medium or multiple media (e.g., a centralized or distributed database, and/or associated caches and servers) that store the one or more instructions 524. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 524 may further be transmitted or received over a communications network 526 using a transmission medium via the network interface device 520 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

### ADDITIONAL NOTES & EXAMPLES

Example 1 is a system for secure account access control, the system comprising: a communication circuit to receive, from a client computer associated with a human client: an encrypted payload, the encrypted payload encrypted with a representative key associated with a human representative, the human representative having an in-person relationship with the human client; and configuration data including a list of recipients, the list including the human representative; and a cryptographic circuit to encrypt the encrypted payload with a platform key, to produce a doubly-encrypted payload; wherein the communication circuit is to transmit the doubly-encrypted payload to those on the list of recipients.

In Example 2, the subject matter of Example 1 optionally includes wherein the encrypted payload is encrypted using an asymmetric key scheme, and wherein the representative key is a public key associated with the human representative.

In Example 3, the subject matter of any one or more of Examples 1-2 optionally include wherein the encrypted payload is encrypted using a symmetric key scheme.

In Example 4, the subject matter of any one or more of Examples 1-3 optionally include wherein the encrypted payload includes sensitive data associated with the human client.

In Example 5, the subject matter of Example 4 optionally includes wherein the sensitive data includes at least one of: a usemame, a password, a personal identification number, or an account number.

In Example 6, the subject matter of any one or more of Examples 1-5 optionally include wherein the list of recipients includes at least one of an executor or a conservator of the human client.

In Example 7, the subject matter of any one or more of Examples 1-6 optionally include a task manager coupled to the communication circuit, wherein the communication circuit is to receive a request from the human representative to release an unlock platform key to decrypt the doubly-encrypted payload; wherein the task manager is to, in response to the communication circuit receiving the request to release the unlock platform key, confirm a status of the human client before releasing the unlock platform key to the human representative.

In Example 8, the subject matter of Example 7 optionally includes wherein to confirm the status of the human client, the task manager is to: access a list of contacts provided by the human client; query at least a portion of the contacts in the list of contacts to confirm the status of the human client; and confirm the status of the human client based on the responses to the query from the contacts.

In Example 9, the subject matter of Example 8 optionally includes wherein to query the contacts in the list of contacts, the task manager is to transmit an electronic message to the contacts in the list of contacts, the electronic message including a query of whether the contacts are able to confirm the status of the human client.

In Example 10, the subject matter of Example 9 optionally includes wherein the electronic message is an email.

In Example 11, the subject matter of any one or more of Examples 9-10 optionally include wherein the electronic message incudes a link to a web survey.

In Example 12, the subject matter of any one or more of Examples 9-11 optionally include wherein the electronic message is a text message.

In Example 13, the subject matter of any one or more of Examples 8-12 optionally include wherein to query the contacts in the list of contacts, the task manager is to initiate delivery of a non-electronic message to the contacts in the list of contacts, the non-electronic message including a query of whether the contacts are able to confirm the status of the human client.

In Example 14, the subject matter of Example 13 optionally includes wherein the non-electronic message comprises a paper delivered through courier or mail service.

In Example 15, the subject matter of any one or more of Examples 8-14 optionally include wherein to query the contacts in the list of contacts, the task manager is to transmit a request via an application programming interface to the contacts in the list of contact.

In Example 16, the subject matter of Example 15 optionally includes wherein the request is transmitted to a government office via the application programming interface.

In Example 17, the subject matter of any one or more of Examples 8-16 optionally include wherein to confirm the status of the human client based on the responses to the query from the contacts, the task manager is to: calculate a number of negative responses, the negative responses indicating that an expected status of the human client is not valid; and confirm the status of the human client when the number of negative responses is less than a threshold.

In Example 18, the subject matter of Example 17 optionally includes wherein the threshold is one negative response.

In Example 19, the subject matter of any one or more of Examples 17-18 optionally include wherein the threshold is a user configurable value, configured by the human client.

In Example 20, the subject matter of any one or more of Examples 17-19 optionally include wherein the threshold is based on a ratio of positive responses to negative responses.

In Example 21, the subject matter of any one or more of Examples 7-20 optionally include wherein the status of the human client is an incapacitated status.

In Example 22, the subject matter of any one or more of Examples 7-2.1 optionally include wherein the status of the human client is a deceased status.

Example 23 is a method of secure account access control, the method comprising: receiving, from a client computer associated with a human client, an encrypted payload, the encrypted payload encrypted with a representative key associated with a human representative, the human representative having an in-person relationship with the human client; receiving, from the client computer, configuration data including a list of recipients, the list including the human representative; encrypting the encrypted payload with a platform key, to produce a doubly-encrypted payload; and transmitting the doubly-encrypted payload to those on the list of recipients.

In Example 24, the subject matter of Example 23 optionally includes wherein the encrypted payload is encrypted using an asymmetric key scheme, and wherein the representative key is a public key associated with the human representative.

In Example 25, the subject matter of any one or more of Examples 23-24 optionally include wherein the encrypted payload is encrypted using a symmetric key scheme.

In Example 26, the subject matter of any one or more of Examples 23-25 optionally include wherein the encrypted payload includes sensitive data associated with the human client.

In Example 27, the subject matter of Example 26 optionally includes wherein the sensitive data includes at least one of: a username, a password, a personal identification number, or an account number.

In Example 28, the subject matter of any one or more of Examples 23-27 optionally include wherein the list of recipients includes at least one of: an executor or a conservator of the human client.

In Example 29, the subject matter of any one or more of Examples 23-28 optionally include receiving a request from the human representative to release an unlock platform key to decrypt the doubly-encrypted payload; and confirming a status of the human client before releasing the unlock platform key to the human representative.

In Example 30, the subject matter of Example 29 optionally includes wherein confirming the status of the human client comprises: accessing a list of contacts provided by the human client; querying at least a portion of the contacts in the list of contacts to confirm the status of the human client; and confirming the status of the human client based on the responses to the query from the contacts.

In Example 31, the subject matter of Example 30 optionally includes wherein querying the contacts in the list of contacts comprises transmitting an electronic message to the contacts in the list of contacts, the electronic message including a query of whether the contacts are able to confirm the status of the human client.

In Example 32, the subject matter of Example 31 optionally includes wherein the electronic message is an email.

In Example 33, the subject matter of any one or more of Examples 31-32 optionally include wherein the electronic message incudes a link to a web survey.

In Example 34, the subject matter of any one or more of Examples 31-33 optionally include wherein the electronic message is a text message.

In Example 35, the subject matter of any one or more of Examples 30-34 optionally include wherein querying the contacts in the list of contacts comprises initiating delivery of a non-electronic message to the contacts in the list of contacts, the non-electronic message including a query of whether the contacts are able to confirm the status of the human client.

In Example 36, the subject matter of Example 35 optionally includes wherein the non-electronic message comprises a paper delivered through courier or mail service.

In Example 37, the subject matter of any one or more of Examples 30-36 optionally include wherein querying the contacts in the list of contacts comprises transmitting a request via an application programming interface to the contacts in the list of contact.

In Example 38, the subject matter of Example 37 optionally includes wherein the request is transmitted to a government office via the application programming interface.

In Example 39, the subject matter of any one or more of Examples 30-38 optionally include wherein confirming the status of the human client based on the responses to the query from the contacts comprises: calculating a number of negative responses, the negative responses indicating that an expected status of the human client is not valid; and confirming the status of the human client when the number of negative responses is less than a threshold.

In Example 40, the subject matter of Example 39 optionally includes wherein the threshold is one negative response.

In Example 41, the subject matter of any one or more of Examples 9-40 optionally include wherein the threshold is a user configurable value, configured by the human client.

In Example 42, the subject matter of any one or more of Examples 39-41 optionally include wherein the threshold is based on a ratio of positive responses to negative responses.

In Example 43, the subject matter of any one or more of Examples 29-42 optionally include wherein the status of the human client is an incapacitated status.

In Example 44, the subject matter of any one or more of Examples 29-43 optionally include wherein the status of the human client is a deceased status.

Example 45 is at least one machine-readable medium including instructions, which when executed by a machine, cause the machine to perform operations of any of the methods of Examples 23-44.

Example 46 is an apparatus comprising means for performing any of the methods of Examples 23-44.

Example 47 is an apparatus for secure account access control, the apparatus comprising: means for receiving, from a client computer associated with a human client, an encrypted payload, the encrypted payload encrypted with a representative key associated with a human representative, the human representative having an in-person relationship with the human client; means for receiving, from the client computer, configuration data including a list of recipients, the list including the human representative; means for encrypting the encrypted payload with a platform key, to produce a doubly-encrypted payload; and means for transmitting the doubly-encrypted payload to those on the list of recipients.

In Example 48, the subject matter of Example 47 optionally includes wherein the encrypted payload is encrypted using an asymmetric key scheme, and wherein the representative key is a public key associated with the human representative.

In Example 49, the subject matter of any one or more of Examples 47-48 optionally include wherein the encrypted payload is encrypted using a symmetric key scheme.

In Example 50, the subject matter of any one or more of Examples 47-49 optionally include wherein the encrypted payload includes sensitive data associated with the human client.

In Example 51, the subject matter of Example 50 optionally includes wherein the sensitive data includes at least one of: a username, a password, a personal identification number, or an account number.

In Example 52, the subject matter of any one or more of Examples 47-51 optionally include wherein the list of recipients includes at least one of: an executor or a conservator of the human client.

In Example 53, the subject matter of any one or more of Examples 47-52 optionally include means for receiving a request from the human representative to release an unlock platform key to decrypt the doubly-encrypted payload; and means for confirming a status of the human client before releasing the unlock platform key to the human representative.

In Example 54, the subject matter of Example 53 optionally includes wherein the means for confirming the status of the human client comprises: means for accessing a list of contacts provided by the human client; means for querying at least a portion of the contacts in the list of contacts to confirm the status of the human client; and means for confirming the status of the human client based on the responses to the query from the contacts.

In Example 55, the subject matter of Example 54 optionally includes wherein the means for querying the contacts in the list of contacts comprise means for transmitting an electronic message to the contacts in the list of contacts, the electronic message including a query of whether the contacts are able to confirm the status of the human client.

In Example 56, the subject matter of Example 55 optionally includes wherein the electronic message is an email.

In Example 57, the subject matter of any one or more of Examples 55-56 optionally include wherein the electronic message incudes a link to a web survey.

In Example 58, the subject matter of any one or more of Examples 55-57 optionally include wherein the electronic message is a text message.

In Example 59, the subject matter of any one or more of Examples 54-58 optionally include wherein the means for querying the contacts in the list of contacts comprise means for initiating delivery of a non-electronic message to the contacts in the list of contacts, the non-electronic message including a query of whether the contacts are able to confirm the status of the human client.

In Example 60, the subject matter of Example 59 optionally includes wherein the non-electronic message comprises a paper delivered through courier or mail service.

In Example 61, the subject matter of any one or more of Examples 54-60 optionally include wherein the means for querying the contacts in the list of contacts comprise means for transmitting a request via an application programming interface to the contacts in the list of contact.

In Example 62, the subject matter of Example 61 optionally includes wherein the request is transmitted to a government office via the application programming interface.

In Example 63, the subject matter of any one or more of Examples 54-62 optionally include wherein the means for confirming the status of the human client based on the responses to the query from the contacts comprise: means for calculating a number of negative responses, the negative responses indicating that an expected status of the human client is not valid; and means for confirming the status of the human client when the number of negative responses is less than a threshold.

In Example 64, the subject matter of Example 63 optionally includes wherein the threshold is one negative response.

In Example 65, the subject matter of any one or more of Examples 63-64 optionally include wherein the threshold is a user configurable value, configured by the human client.

In Example 66, the subject matter of any one or more of Examples 63-65 optionally include wherein the threshold is based on a ratio of positive responses to negative responses.

In Example 67, the subject matter of any one or more of Examples 53-66 optionally include wherein the status of the human client is an incapacitated status.

In Example 68, the subject matter of any one or more of Examples 53-67 optionally include wherein the status of the human client is a deceased status.

Example 69 is at least one machine-readable medium including instructions to provide secure account access control, which when executed by a machine, cause the machine to: receive, from a client computer associated with a human client, an encrypted payload, the encrypted payload encrypted with a representative key associated with a human representative, the human representative having an in-person relationship with the human client; receive, from the client computer, configuration data including a list of recipients, the list including the human representative; encrypt the encrypted payload with a platform key, to produce a doubly-encrypted payload; and transmit the doubly-encrypted payload to those on the list of recipients.

In Example 70, the subject matter of Example 69 optionally includes wherein the encrypted payload is encrypted using an asymmetric key scheme, and wherein the representative key is a public key associated with the human representative.

In Example 71, the subject matter of any one or more of Examples 69-70 optionally include wherein the encrypted payload is encrypted using a symmetric key scheme.

In Example 72, the subject matter of any one or more of Examples 69-71 optionally include wherein the encrypted payload includes sensitive data associated with the human client.

In Example 73, the subject matter of Example 72 optionally includes wherein the sensitive data includes at least one of: a username, a password, a personal identification number, or an account number.

In Example 74, the subject matter of any one or more of Examples 69-73 optionally include wherein the list of recipients includes at least one of: an executor or a conservator of the human client.

In Example 75, the subject matter of any one or more of Examples 69-74 optionally include instructions to: receive a request from the human representative to release an unlock platform key to decrypt the doubly-encrypted payload; and confirm a status of the human client before releasing the unlock platform key to the human representative.

In Example 76, the subject matter of Example 75 optionally includes wherein the instructions to confirm the status of the human client comprise instructions to: access a list of contacts provided by the human client; query at least a portion of the contacts in the list of contacts to confirm the status of the human client; and confirm the status of the human client based on the responses to the query from the contacts.

In Example 77, the subject matter of Example 76 optionally includes wherein the instructions to query the contacts in the list of contacts comprise instructions to transmit an electronic message to the contacts in the list of contacts, the electronic message including a query of whether the contacts are able to confirm the status of the human client.

In Example 78, the subject matter of Example 77 optionally includes wherein the electronic message is an email.

In Example 79, the subject matter of any one or more of Examples 77-78 optionally include wherein the electronic message incudes a link to a web survey.

In Example 80, the subject matter of any one or more of Examples 77-79 optionally include wherein the electronic message is a text message.

In Example 81, the subject matter of any one or more of Examples 76-80 optionally include wherein the instructions to query the contacts in the list of contacts comprise instructions to initiate delivery of a non-electronic message to the contacts in the list of contacts, the non-electronic message including a query of whether the contacts are able to confirm the status of the human client.

In Example 82, the subject matter of Example 81 optionally includes wherein the non-electronic message comprises a paper delivered through courier or mail service.

In Example 83, the subject matter of any one or more of Examples 76-82 optionally include wherein the instructions to query the contacts in the list of contacts comprise instructions to transmit a request via an application programming interface to the contacts in the list of contact.

In Example 84, the subject matter of Example 83 optionally includes wherein the request is transmitted to a government office via the application programming interface.

In Example 85, the subject matter of any one or more of Examples 76-84 optionally include wherein the instructions to confirm the status of the human client based on the responses to the query from the contacts comprise instructions to: calculate a number of negative responses, the negative response indicating that an expected status of the human client is not valid; and confirm the status of the human client when the number of negative responses is less than a threshold.

In Example 86, the subject matter of Example 85 optionally includes wherein the threshold is one negative response.

In Example 87, the subject matter of any one or more of Examples 85-86 optionally include wherein the threshold is a user configurable value, configured by the human client.

In Example 88, the subject matter of any one or more of Examples 85-87 optionally include wherein the threshold is based on a ratio of positive responses to negative responses.

In Example 89, the subject matter of any one or more of Examples 75-88 optionally include wherein the status of the human client is an incapacitated status.

In Example 90, the subject matter of any one or more of Examples 75-89 optionally include wherein the status of the human client is a deceased status.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document, for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. A system for secure account access control, the system comprising:
a communication circuit to receive, from a client computer associated with a human client:
an encrypted payload, the encrypted payload encrypted with a representative key associated with a human representative, the human representative having an in-person relationship with the human client; and
configuration data including a list of recipients, the list including the human representative; and
a cryptographic circuit to encrypt the encrypted payload with a platform key, to produce a doubly-encrypted payload;
wherein the communication circuit is to transmit the doubly-encrypted payload to those on the list of recipients.

2. The system of claim 1, wherein the encrypted payload is encrypted using an asymmetric key scheme, and wherein the representative key is a public key associated with the human representative.

3. The system of claim 1, wherein the encrypted payload includes sensitive data associated with the human client.

4. The system of claim 3, wherein the sensitive data includes at least one of: a username, a password, a personal identification number, or an account number.

5. The system of claim 1, wherein the list of recipients includes at least one of: an executor or a conservator of the human client.

6. The system of claim 1, further comprising a task manager coupled to the communication circuit,
wherein the communication circuit is to receive a request from the human representative to release an unlock platform key to decrypt the doubly-encrypted payload;
wherein the task manager is to, in response to the communication circuit receiving the request to release the unlock platform key, confirm a status of the human client before releasing the unlock platform key to the human representative.

7. The system of claim 6, wherein to confirm the status of the human client, the task manager is to:
access a list of contacts provided by the human client;
query at least a portion of the contacts in the list of contacts to confirm the status of the human client; and
confirm the status of the human client based on the responses to the query from the contacts.

8. The system of claim 7, wherein to query the contacts in the list of contacts, the task manager is to transmit an electronic message to the contacts in the list of contacts, the electronic message including a query of whether the contacts are able to confirm the status of the human client.

9. The system of claim 7, wherein to query the contacts in the list of contacts, the task manager is to initiate delivery of a non-electronic message to the contacts in the list of contacts, the non-electronic message including a query of whether the contacts are able to confirm the status of the human client.

10. The system of claim 7, wherein to query the contacts in the list of contacts, the task manager is to transmit a request via an application programming interface to the contacts in the list of contact.

11. The system of claim 10, wherein the request is transmitted to a government office via the application programming interface.

12. The system of claim 7; wherein to confirm the status of the human client based on the responses to the query from the contacts, the task manager is to:
calculate a number of negative responses, the negative responses indicating that an expected status of the human client is not valid; and
confirm the status of the human client when the number of negative responses is less than a threshold.

13. A method of secure account access control, the method comprising:
receiving, from a client computer associated with a human client, an encrypted payload, the encrypted payload encrypted with a representative key associated with a human representative, the human representative having an in-person relationship with the human client;
receiving, from the client computer, configuration data including a list of recipients, the list including the human representative;
encrypting the encrypted payload with a platform key, to produce a doubly-encrypted payload; and
transmitting the doubly-encrypted payload to those on the list of recipients.

14. The method of claim 13, wherein the encrypted payload is encrypted using a symmetric key scheme.

15. The method of claim 13, wherein the encrypted payload includes sensitive data associated with the human client.

16. The method of claim 15, wherein the sensitive data includes at least one of: a username, a password, a personal identification number, or an account number.

17. The method of claim 13, further comprising:
receiving a request from the human representative to release an unlock platform key to decrypt the doubly-encrypted payload; and
confirming a status of the human client before releasing the unlock platform key to the human representative.

18. The method of claim 17, wherein confirming the status of the human client comprises:
accessing a list of contacts provided by the human client;
querying at least a portion of the contacts in the list of contacts to confirm the status of the human client; and
confirming the status of the human client based on the responses to the query from the contacts.

19. The method of claim 18, wherein confirming the status of the human client based on the responses to the query from the contacts comprises:
calculating a number of negative responses, the negative responses indicating that an expected status of the human client is not valid; and
confirming the status of the human client when the number of negative responses is less than a threshold.

20. The method of claim 19, wherein the threshold is one negative response.

21. At least one machine-readable medium including instructions to provide secure account access control, which when executed by a machine, cause the machine to:
receive, from a client computer associated with a human client, an encrypted payload, the encrypted payload encrypted with a representative key associated with a human representative, the human representative having an in-person relationship with the human client;
receive, from the client computer, configuration data including a list of recipients, the list including the human representative;
encrypt the encrypted payload with a platform key, to produce a doubly-encrypted payload; and
transmit the doubly-encrypted payload to those on the list of recipients.

22. The machine-readable medium of claim 21, further comprising instructions to:
receive a request from the human representative to release an unlock platform key to decrypt the doubly-encrypted payload; and
confirm a status of the human client before releasing the unlock platform key to the human representative.

23. The machine-readable medium of claim 22, wherein the instructions to confirm the status of the human client comprise instructions to:
access a list of contacts provided by the human client;
query at least a portion of the contacts in the list of contacts to confirm the status of the human client; and
confirm the status of the human client based on the responses to the query from the contacts.

24. The machine-readable medium of claim 23, wherein the instructions to confirm the status of the human client based on the responses to the query from the contacts comprise instructions to:
calculate a number of negative responses, the negative responses indicating that an expected status of the human client is not valid; and
confirm the status of the human client when the number of negative responses is less than a threshold.

25. The machine-readable medium of claim 24, wherein the threshold is based on a ratio of positive responses to negative responses.
